(19) United States
(12) Patent Application Publication
(10) Pub. No.: US 2011/0318548 A1
(43) Pub. Date: Dec. 29, 2011

(54) Adhesive Backed Absorbent Mat

(75) Inventors: Raymond L. Fedeli, Altoona, PA (US); Dane R. Jackson, Port Matilda, PA (US); Brian Dennis Kratzer, Huntingdon, PA (US); Mark S. Woytowich, State College, PA (US); Daniel A. Silver, State College, PA (US)

(73) Assignee: New Pig Corporation, Tipton, PA (US)

(21) Appl. No.: 13/169,473

(22) Filed: Jun. 27, 2011

Related U.S. Application Data
(60) Provisional application No. 61/358,978, filed on Jun. 28, 2010.

(51) Int. Cl. B32B 7/06; B32B 33/00; B32B 5/02; B32B 7/14; B32B 27/00

(52) U.S. Cl. 428/196; 428/352; 428/195.1; 442/181; 442/327

(57) ABSTRACT

The invention includes an absorbent mat including an absorbent layer having a first surface and an opposing second surface and an adhesive layer on at least a portion of the first surface of the absorbent layer. The opposing second surface is structured and arranged such that the adhesive layer is releasably adhereable with the second surface.

### CROSS REFERENCE TO RELATED APPLICATION

This application claims the benefit of U. S. Provisional Patent Application Serial No. 61/358,978 filed Jun. 28, 2010, which is fully incorporated herein by reference.

### BACKGROUND OF THE INVENTION

This invention is related to an adhesive backed absorbent mat. In one aspect, the adhesive backed absorbent mat does not require a release liner.

Absorbent mats having an adhesive backing are generally known. Typically, a release liner is provided on the adhesive surface in order that the absorbent mat can be put in the form of a roll or stacked upon itself for storage or shipping. Once the absorbent mat is ready for use, the user must remove the release liner while trying to align or position the absorbent mat into the desired position such that the adhesive backing will maintain the absorbent mat in the desired location. The task of removing the release liner while trying to align the mat into place can be difficult and often results in the adhesive backing contacting and adhering to an unintended surface.

Thus, it would be advantageous to provide an improved adhesive backed absorbent mat that overcomes limitations and disadvantages of known such devices.

### SUMMARY OF THE INVENTION

In one aspect, the invention includes an absorbent mat including an absorbent layer having a first surface and an opposing second surface and an adhesive layer on at least a portion of the first surface of the absorbent layer. The opposing second surface is structured and arranged such that the adhesive layer is releasably adhereable with the second surface.

In another aspect of the invention, an absorbent mat includes an absorbent layer having a first surface and an opposing second surface, an adhesive layer on at least a portion of the first surface of the absorbent layer and a reinforcing release layer on the second surface. The reinforcing release layer is structured and arranged such that the adhesive layer is releasably adhereable with the reinforcing release layer.

In yet another aspect of the invention, an absorbent mat includes an absorbent layer having a first surface and an opposing second surface, a reinforcing backing layer on the first surface and an adhesive layer on at least a portion of the reinforcing backing layer. The opposing second surface is structured and arranged such that the adhesive is releasably adhereable with the second surface.

These and other aspects of the present invention will be more fully understood following a review of this specification and drawings.

### BRIEF DESCRIPTION OF THE DRAWINGS

FIG. 1 is an adhesive backed absorbent mat in the form of a roll, in accordance with an aspect of the invention.

FIG. 2 is a sectional view of an adhesive backed absorbent mat, in accordance with another aspect of the invention.

FIG. 3 is a partial sectional view of an adhesive backed absorbent mat, in accordance with yet another aspect of the invention.

### DETAILED DESCRIPTION

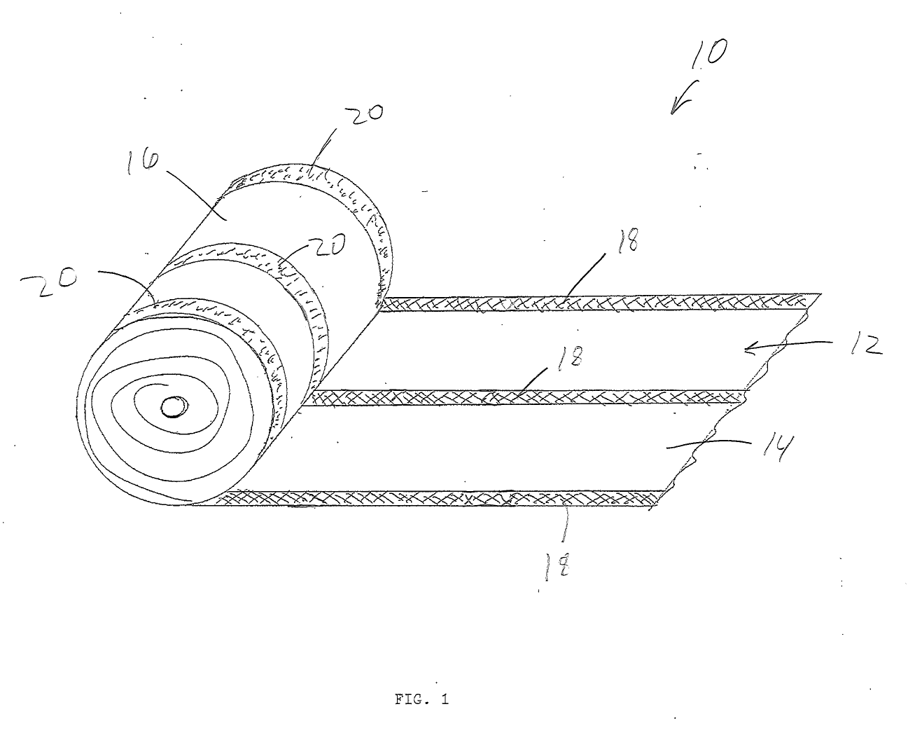

Referring to FIG. 1, there is illustrated an adhesive backed absorbent mat 10, in accordance with an aspect of the invention. The absorbent mat 10 includes an absorbent layer 12 having a first surface 14 and an opposing second surface 16. As illustrated in FIG. 1, the absorbent mat may be in the form of a roll, or may be provided in single sheets that may be stacked on top of one another for purposes of storage and/or shipping, etc.

Still referring to FIG. 1, the absorbent layer 12 includes an adhesive layer or adhesive material 18 formed on at least a portion of the first surface 14. In one aspect, the adhesive layer 18 is a pressure sensitive adhesive. For example, the adhesive layer 18 when formed as a pressure sensitive adhesive layer may be, for example, a hot melt type pressure sensitive adhesive or a liquid carrier based type pressure sensitive adhesive. As illustrated in FIG. 1, the adhesive layer 18 may be applied in multiple strips to the first surface 14 of the absorbent layer 18. However, it will appreciated that the adhesive layer 18 may be applied in various arrangements, configurations and sizes depending upon the particular desired application of the absorbent mat 10.

Still referring to FIG. 1, the opposing second surface 16 of the absorbent layer 12 is structured and arranged such that the adhesive layer 18 is releasably adhereable with the second surface 16. Thus, when the absorbent mat is either in the form of a roll as illustrated in FIG. 1, or in other configurations, then the roll may be unrolled such that the second surface 16 does not adhere to the adhesive layer 18 as will be described in more detail herein.

Still referring to FIG. 1, the opposing second surface 16 may include a release coating 20 applied to at least a portion thereof, in accordance with an aspect of the invention. The release coating 20 is generally applied to the second surface 16 opposite to the adhesive layer 18 that is formed on at least a portion of the first surface 14 of the absorbent layer 12. By applying the release coating 20 to the second surface 16 generally opposite the adhesive layer 18, the adhesive layer 18 contacts the release coating 20 when the adhesive backed absorbent mat 10 is either rolled or stacked. Then, whenever the absorbent mat 10 is either unrolled or unstacked, the adhesive layer 18 does not adhere to the second surface 16 due to the existence of the release coating 20.

Therefore, it will be appreciated that the invention includes the absorbent mat 10 having the absorbent layer 12 that can absorb, for example, aqueous fluids and/or hydrocarbon based fluids. The absorbent layer 12 may be formed of, for example, polyethylene, polypropylene, polyester, nylon, synthetic fibers, pulp, cotton, cellulosic material, and combinations thereof The absorbent mat 10 includes the adhesive layer 18, e.g., a pressure sensitive adhesive, that allows it to adhere to floors, walls or other flat or curved surfaces. For the absorbent mat 10, the surface construction, surface chemical treatment, e.g., the release coating 20, and the adhesive layer 18 are all selected and balanced to produce a mat in which the adhesive layer 18 does not stick to the absorbent mat's opposite surface 16 when wound up in a roll or stacked upon itself. This arrangement eliminates the need for a release liner for the mat 10 when transported, stored or used at 120° F. or less. Further adjustments of these parameters can make the release liner unnecessary at elevated temperatures, e.g., greater than 120° F. typically observed during warmer weather in a warehouse, in vehicle trunks and transportation trailers. It will be appreciated that the end user can easily unwind or unstack the absorbent mat 10 for use without the adhesive layer 18 damaging the exposed mat's face. The adhesive layer 18 can adhere the mat 10 to surfaces selected for use. Since there is no release liner required, the user eliminates the step of pulling off the liner while trying to align the mat 10 into place. This makes placement easier, helps ensure proper placement of the mat and reduces waste by not having a liner to dispose of.

The various parameters of the absorbent mat 10 are selected so that the adhesive layer 18 does not permanently adhere to the opposite surface 16 of the mat 10. The adhesive layer 18 will easily release from the opposite surface 16 when pulled apart and will not mar that surface, nor will it leave any adhesive residue behind. That is, the adhesive layer 18 is selected so as to have a lower affinity to the mat's opposite surface 16 than the mat's surface that the adhesive layer is affixed to. Also, the adhesive layer 18 is selected to allow the mat 10 to be applied and removed several times so that the surface to which it is adhered to can be cleaned and/or the mat repositioned.

The adhesive layer 18 is also selected so that small amounts of contaminants on the surface that the mat 10 is being applied to do not interfere with its adhesiveness. These contaminants can be, for example, water, oils, grease and/or dirt. The adhesive layer 18 retains enough adhesive strength after removal from its packaged roll or stack to be able to cling to vertical and horizontal surfaces and can be removed later without damaging the surface it was applied to or leaving any residue of the adhesive layer 18 behind.

The adhesive layer 18 is also selected according to the in-use conditions of the absorbent mat 10. An adhesive backed absorbent mat 10 that is used in an industrial, e.g., machine shop, or commercial, e.g., food service, setting where the floor may be unsealed, rough concrete or tile that may be contaminated with oil and/or dust and dirt will require a more aggressive adhesive layer 18. Therefore, in one aspect, the pressure sensitive adhesive layer 18 may have a peel value in the range of about 2 ounces per inch to about 35 ounces per inch wherein peel value is measured per the Pressure Sensitive Tape Council test method. For the example of most industrial or commercial applications, the adhesive layer 18 may have a peel value of about 25 ounces per inch. An adhesive backed absorbent mat 10 that is intended for use in a medical operating room where the floor is smooth and extremely clean will require a less aggressive adhesive layer 18, for example, having a peel value of less than 15 ounces per inch, in one example from 5 to 10 ounces per inch. Additionally, an adhesive layer 18 with a peel value of less than 10 ounces per inch will not adhere to surgical gloves of operating room personnel as they are handling the mat 10.

The absorbent mat 10 may be made by any of the commonly known processes in use for forming absorbent mats such as, but not limited to, dry-laid, air-laid, wet-laid, needle punched, and meltblown, or any combinations thereof

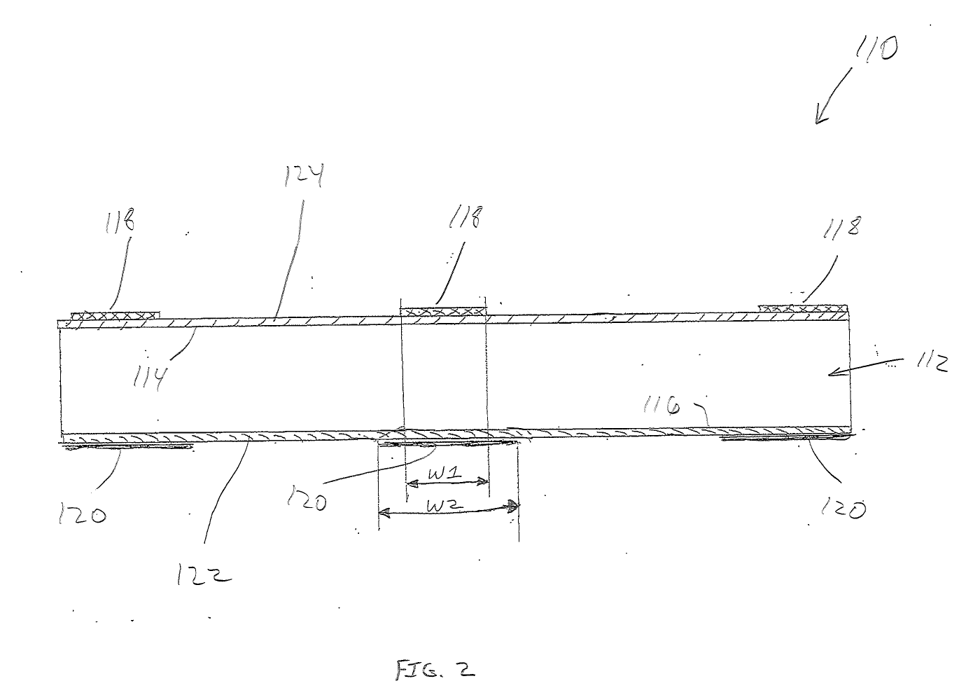

Referring to FIG. 2, there is illustrated a partial sectional view of an additional adhesive backed absorbent mat 110, in accordance with an aspect of the invention. The absorbent mat 110 includes an absorbent layer 112 having a first surface 114 and an opposing second surface 116. The absorbent mat 110 may include a reinforcing release layer 122 formed on the opposing second surface 116. The reinforcing release layer 122 is structured and arranged such that an adhesive layer 118 is releasably adhereable to the reinforcing release layer 122. The reinforcing release layer 122 may include a release coating 120 applied thereto, or the reinforcing release layer may be configured such that no release coating 120 is necessary. The reinforcing release layer 122 may include, for example, nylon, polyethelyne, polypropylene, polyester nonwoven, woven synthetic textile or combinations thereof

Still referring to FIG. 2, a reinforcing backing layer 124 may be formed on at least a portion of the first surface 114. The adhesive layer 118 may be formed on the reinforcing backing layer 124. The reinforcing backing layer 124 may include, for example, polyethylene, polypropylene, polyester nonwoven, woven synthetic textile, polymeric film or combinations thereof

Still referring to FIG. 2, the adhesive layer 118 may be formed on the reinforcing backing layer 124. In addition, the release coating 120 may be applied to the reinforcing release layer 122. As illustrated, the release coating 120 is applied generally opposite to the adhesive layer 118. In addition, the release coating 120 is applied to a larger area than the area covered by the opposing adhesive layer 118. For example, the adhesive layer 118 may have a width W1 while the release coating 120 is applied to a larger area having a greater width of W2. Thus, it will be appreciated that the absorbent mat of the invention may be formed in various configurations that include or do not include the reinforcing release layer 122, the reinforcing backing layer 124 and the release coating 120.

In another aspect, the reinforcing backing layer 124 and/or the reinforcing release layer 122 may be permanently attached to the absorbent layer 112 by, for example, means of thermal or ultrasonic bonding, adhesive bonding with a flexible adhesive, and/or mechanical attachment, such as stitchbonded.

Referring generally to FIG. 1 and/or FIG. 2, various other aspects of the invention will be described. The first side 14 of the absorbent layer 12 needs to have adequate temperature resistance to receive a hot melt pressure sensitive adhesive and sufficient strength and affinity to the pressure sensitive adhesive so that the adhesive remains attached after removal from the applied surface. This can be done either within the construction of the absorbent mat 10 as illustrated in FIG. 1 or by adding the additional reinforcing backing layer 124 illustrated in FIG. 2. In one example, the adhesive layer 18 is a hot melt pressure sensitive adhesive that is typically applied only over a portion of the surface 14 to reduce material costs. The adhesive layer 18 may be applied near opposite edges and, depending on its width, one or more stripes of the adhesive layer 18 may be applied in the center as well. An example of a suitable pressure sensitive adhesive is Ellsworth Adhesives Company type HM-258-K2 adhesive.

Alternatively, the pressure sensitive adhesive may be a liquid carrier based type that is applied as a solution or as an emulsion that is subsequently dried to remove the liquid carrier, leaving the active pressure sensitive adhesive. In this case, the first surface 14, i.e. the adhesive layer 18 side of the mat 10, needs to limit the absorption of the pressure sensitive adhesive solution or emulsion into the mat 10 so that the active pressure sensitive adhesive will remain on the surface. The reinforcing backing layer 124 can provide this function as it is formed of a material, as described herein, that resists absorption of the solvent or emulsion based pressure sensitive adhesive.

In accordance with another aspect of the invention, a suitable non-hot melt pressure sensitive adhesive is one based on acrylic chemistry. These are available in both a cross-linked and a non-cross-linked version. In one aspect, a cross-linked acrylic pressure sensitive adhesive is used since it is less likely to migrate over time and can resist higher temperatures often seen during transportation and storage. When the mat is rolled or stacked prior to use, migration of the pressure sensitive adhesive onto the adjacent surface and into the adjacent surface's fiber matrix can cause unwanted bonding between the adjacent surfaces 14 and 16. This unwanted bonding may be minor, resulting in some fiber contamination of the adhesive, thus lessening its effectiveness or severe enough that the mat 10 cannot be separated or unrolled for use. Cross-linked pressure sensitive adhesives minimize this undesired bonding. In another aspect of the invention, the overall adhesiveness of the mat 10 may be controlled by altering the chemical composition of the pressure sensitive adhesive or simply by altering the total amount of pressure sensitive adhesive that is applied to the mat 10. The total amount of pressure sensitive adhesive can be varied by adjusting the basis weight of the pressure sensitive adhesive as applied or by varying the total area that the pressure sensitive adhesive is applied to. For example, a mat 10 that is designed to adhere to a vertical surface and has to suspend its own weight may have more adhesive spread out over the entire side 14 of the mat 10 versus a mat for a floor that has less adhesive that is applied in strips.

In another aspect of the invention, the second surface 16 of the mat 10 needs to have sufficient strength to prevent the pressure sensitive adhesive from destroying its surface when it is unwound from a roll. If the surface 16 strength is insufficient, then the reinforcing release layer 122 (as shown and described in FIG. 2) can be added to the surface. As described, in addition to or in place of the reinforcing release layer 122, a release coating 120 may be applied that further inhibits adhesion to the surface. Preferably, the release coating 120 does not retard oil or water absorption and is preferably applied only on the surface area that the adhesive contacts. Some common release agent chemistries are based on, for example, but not limited to, silicon, waxes, carbamates, fluoropolymers, acrylic copolymers and polyamide resins.

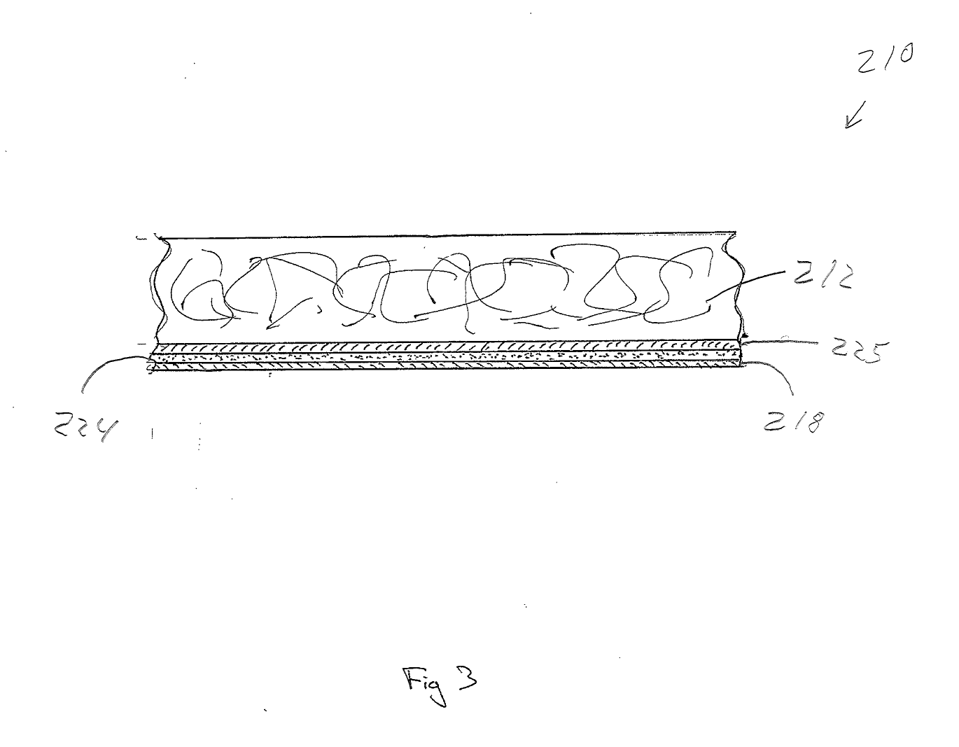

FIG. 3 illustrates an additional adhesive backed absorbent mat 210, in accordance with an aspect of the invention. A reinforcing layer 224 is precoated with an adhesive layer 218. This in turn is laminated to the absorbent layer 212 using a hot melt adhesive or an extruded molten layer of a polyethylene based resin 225 to permanently attach the absorbent layer 212 to the reinforcing layer 224 that is precoated with the layer 218.

Whereas particular embodiments of this invention have been described above for purposes of illustration, it will be evident to those skilled in the art that numerous variations of the details of the present invention may be made without departing from the invention as defined in the appended claims.

What is claimed is:

1. An absorbent mat, comprising:
an absorbent layer having a first surface and an opposing second surface; and
an adhesive layer on at least a portion of the first surface of the absorbent layer,
wherein the opposing second surface is structured and arranged such that the adhesive layer is releasably adhereable with the second surface.

2. The absorbent mat of claim 1, wherein the adhesive layer is a pressure sensitive adhesive.

3. The absorbent mat of claim 2, wherein the pressure sensitive adhesive has a peel value in the range of about 2 ounces per inch to about 35 ounces per inch.

4. The absorbent mat of claim 2, wherein the pressure sensitive adhesive is a hot melt type pressure sensitive adhesive or a liquid carrier based type pressure sensitive adhesive.

5. The absorbent mat of claim 1, wherein the second surface includes a release coating applied to at least a portion thereof

6. The absorbent mat of claim 5, wherein the release coating is applied to the second surface opposite to the adhesive layer that is on at least a portion of the first surface.

7. The absorbent mat of claim 6, wherein the release coating is applied to a larger area than the area covered by the opposing adhesive layer.

8. The absorbent mat of claim 1, wherein the absorbent layer includes polyethylene, polypropylene, polyester, nylon, synthetic fibers, pulp, cotton, cellulosic material, and combinations thereof

9. An absorbent mat, comprising:
an absorbent layer having a first surface and an opposing second surface;
an adhesive layer on at least a portion of the first surface of the absorbent layer; and
a reinforcing release layer on the second surface, wherein the reinforcing release layer is structured and arranged such that the adhesive layer is releasably adhereable with the reinforcing release layer.

10. The absorbent mat of claim 9, wherein the adhesive layer is a pressure sensitive adhesive.

11. The absorbent mat of claim 10, wherein the pressure sensitive adhesive has a peel value in the range of about 2 ounces per inch to about 35 ounces per inch.

12. The absorbent mat of claim 10, wherein the pressure sensitive adhesive is a hot melt type pressure sensitive adhesive or a liquid carrier based type pressure sensitive adhesive.

13. The absorbent mat of claim 9, wherein the reinforcing release layer includes a release coating applied to at least a portion thereof

14. The absorbent mat of claim 13, wherein the release coating is applied to the reinforcing release layer opposite to the adhesive layer that is on at least a portion of the first surface.

15. The absorbent mat of claim 14, wherein the release coating is applied to a larger area than the area covered by the opposing adhesive layer.

16. The absorbent mat of claim 9, wherein the absorbent layer includes polyethylene, polypropylene, polyester, nylon, synthetic fibers, pulp, cotton, cellulosic material, and combinations thereof

17. The absorbent mat of claim 9, wherein the reinforcing release layer includes nylon, polyethelyne, polypropylene, polyester nonwoven, woven synthetic textile or combinations thereof

18. An absorbent mat, comprising:
an absorbent layer having a first surface and an opposing second surface;
a reinforcing backing layer on the first surface; and
an adhesive layer on at least a portion of the reinforcing backing layer,
wherein the opposing second surface is structured and arranged such that the adhesive layer is releasably adhereable with the second surface.

19. The absorbent mat of claim 18, wherein the adhesive layer is a pressure sensitive adhesive.

20. The absorbent mat of claim 19, wherein the pressure sensitive adhesive has a peel value in the range of about 2 ounces per inch to about 35 ounces per inch.

21. The absorbent mat of claim 19, wherein the pressure sensitive adhesive is a hot melt type pressure sensitive adhesive or a liquid carrier based type pressure sensitive adhesive.

22. The absorbent mat of claim 18, wherein the second surface includes a release coating applied to at least a portion thereof

23. The absorbent mat of claim 22, wherein the release coating is applied to the second surface opposite to the adhesive layer that is on at least a portion of the reinforcing backing layer.

24. The absorbent mat of claim 23, wherein the release coating is applied to a larger area than the area covered by the opposing adhesive layer.

25. The absorbent mat of claim 18, wherein the absorbent layer includes polyethylene, polypropylene, polyester, nylon, synthetic fibers, pulp, cotton, cellulosic material, and combinations thereof

26. The absorbent mat of claim 18, wherein the reinforcing backing layer includes polyethylene, polypropylene, polyester nonwoven, woven synthetic textile, polymeric film or combinations thereof
